(19) United States
(12) Patent Application Publication
(10) Pub. No.: US 2009/0319315 A1
(43) Pub. Date: Dec. 24, 2009

(54) COMMUNITY TO ADDRESS CARBON OFFSETS

(76) Inventor: BENNETT HILL BRANSCOMB, San Francisco, CA (US)

Correspondence Address: WONG, CABELLO, LUTSCH, RUTHERFORD & BRUCCULERI,;L.L.P., 20333 SH 249 6th Floor, HOUSTON, TX, 77070, US

(21) Appl. No.: 12/488,056

(22) Filed: Jun. 19, 2009

Related U.S. Application Data
(60) Provisional application No. 61/074,529, filed on Jun. 20, 2008.

(51) Int. Cl. G06Q 50/00; G06Q 10/00; G06Q 40/00

(52) U.S. Cl. 705/7; 705/30; 705/35

(57) ABSTRACT

A club or community of mineral producers or other interested parties is put together for the purpose of responsibility account for CO2 and/or other pollutants in produced minerals. The community utilizes a community system to track the amount of CO2 that is associated with produced minerals. The community member sponsoring the mineral contributes to the community fund an amount representative of the value of the estimated CO2 as determined by the community system. The community then utilizes the received funds to invest in carbon offset activities which in turn are returned as benefits to the community members so that either those members can sell carbon offset accounted minerals or the community can do so on the community members' behalf.

### CROSS-REFERENCE TO RELATED APPLICATIONS

This application claims the benefit of U.S. Provisional Application Ser. No. 61/074,529 filed Jun. 20, 2008 and entitled “A Members Only Club Trading System For Tracking, Managing, Accounting a Two Stage CO₂ Derivative Product,” the disclosure of which is incorporated herein by reference.

### STATEMENT REGARDING FEDERALLY SPONSORED RESEARCH OR DEVELOPMENT

NOT APPLICABLE

### BACKGROUND OF THE INVENTION

1. Field of the Invention

This invention relates to creating a community of persons or companies related to mineral production to responsibly account for CO₂ or other pollutants early in the process of production, investing in carbon offset activity and selling carbon offset accounted products. The invention also relates to the systems employed to manage and track such a communities' activities.

2. Description of the Related Art Including Information Disclosed Under 37 CFR 1.97 and 1.98

Many natural resources, especially fossil fuels, comprise pollutants which have a negative impact when released into the environment. Some pollutants are impurities in the resource material—e.g., sulfur and mercury in coal—whose level may vary depending on the source and/or processing steps taken during recovery of the resource. Other pollutants result from the use of a resource—e.g., oxides of nitrogen (NOx) and the greenhouse gas carbon dioxide (CO₂) created during the combustion of hydrocarbon fuels.

Absent a recovery mechanism, the carbon in that crude oil will enter the atmosphere (predominately) as CO₂ for that portion of the oil used as fuel but the carbon in the lubricating oil fraction and petrochemical products may not (depending on the form of their ultimate disposal).

Greenhouse gases are components of the atmosphere that contribute to the greenhouse effect. Greenhouse gases include (in the order of relative abundance): water vapor, carbon dioxide, methane, nitrous oxide, and ozone. Greenhouse gases are known to emanate from both natural sources and human activity.

With the increase in concern over global climate change, a great deal of interest has been directed to the emission of greenhouse gases, carbon dioxide in particular. When a hydrocarbon is burned—i.e., oxidized—carbon dioxide and water (both greenhouse gases) are produced. By way of example, consider the combustion (in air) of natural gas (consisting essentially of methane):

CH₄+2O₂→CO₂+2H₂O

The combustion of each molecule of methane produces one molecule of carbon dioxide.

Likewise, consider the combustion (in air) of gasoline (a mixture of hydrocarbons which can be represented by octane, C8H18):

2C₈H₁₈+25O₂→16CO₂+18H₂O

The combustion of each molecule of octane produces eight molecules of carbon dioxide.

Various schemes have been proposed for reallocating the pollution costs associated with using certain resources, such as CO₂. For example, “personal carbon trading” is designed to be a mandatory program wherein emissions credits are equally allocated to individuals on a per capita basis, within national carbon budgets. Individuals would then have to surrender these credits when buying fuel or electricity. Individuals wanting or needing more energy would be able to partake in emissions trading to secure more credits, similar to what companies do now within the European Union Emission Trading Scheme.

The European Union Emission Trading Scheme (EU ETS) is the largest multi-national, greenhouse gas emissions trading scheme. Under the EU ETS, large emitters of carbon dioxide within the EU must monitor and annually report their CO₂ emissions, and are obliged to surrender (give back) every year a number of emission allowances to the government that is equivalent to their CO₂ emissions in that year. The installations may get the allowances without cost from the government, or may purchase them from others (installations, traders, the government.) If an installation has received more free allowances than it needs, it may sell them to anybody.

Emissions trading (sometimes called “cap and trade”) is an administrative approach intended to control pollution by providing economic incentives for achieving reductions in the emissions of pollutants. A central authority (usually a government or international body) sets a limit or cap on the quantity of a particular pollutant that can be emitted. Companies or other groups are issued emission permits and are required to hold an equivalent number of allowances (or credits) which represent the right to emit a specific amount. The total amount of allowances and credits cannot exceed the cap, thereby limiting total emissions to that level. Companies that need to increase their emissions must buy credits from those who pollute less. The transfer of allowances is referred to as a trade. In effect, the buyer is paying a charge for polluting, while the seller is being rewarded for having reduced emissions by more than was required. Thus, in theory, those who can most easily reduce emissions will do so, achieving the pollution reduction at the lowest possible cost to society. There are currently active trading programs in several pollutants. For greenhouse gases, the largest is the European Union Emission Trading Scheme. In the United States there is a national market designed to reduce acid rain and several regional markets in oxides of nitrogen.

A carbon tax is a government-imposed tax on energy sources which produce carbon dioxide. Typically, the price per unit of emissions is fixed—i.e., there is not a fluctuating market price. The European Union has discussed a carbon tax covering its member states to supplement the carbon emissions trading scheme begun in January 2005—the EU ETS trading scheme discussed above.

The purpose of a carbon tax is environmental—to encourage users to reduce their emissions of carbon dioxide and thereby slow global warming. It can be implemented by taxing the burning of fossil fuels—coal, petroleum products such as gasoline and aviation fuel, and natural gas—in proportion to their carbon content. Unlike market-based approaches such as carbon cap-and-trade systems, it has the advantage of being easily understood and the tax revenues generated can be used to fund environmental projects.

On Jan. 1, 1991, Sweden imposed a carbon tax on the use of oil, coal, natural gas, liquefied petroleum gas, petrol, and aviation fuel used in domestic travel. Industrial users paid half the rate and certain high-energy industries such as commercial horticulture, mining, manufacturing and the pulp and paper industry were exempted from the tax. Finland, the Netherlands, and Norway also introduced carbon taxes in the 1990s.

A carbon dioxide (CO₂) sink is a carbon dioxide reservoir that is increasing in size, and is the opposite of a carbon dioxide “source.” The main natural sinks are (1) the oceans and (2) plants and other organisms that use photosynthesis to remove carbon from the atmosphere by incorporating it into biomass and release oxygen into the atmosphere. This concept of CO₂ sinks has become more widely known because the Kyoto Protocol allows the use of carbon dioxide sinks as a form of carbon offset.

Carbon capture and storage is a scheme to mitigate global warming by capturing carbon dioxide (CO₂) from large point sources such as fossil fuel power plants and storing it rather than releasing it into the atmosphere. Technology for large scale capture of CO₂ is commercially available and fairly well developed. Although CO₂ has been injected into geological formations for various purposes, the long term storage of CO₂ is a relatively untried concept and as of the date hereof no large scale power plant is known to operate with a full carbon capture and storage system.

Currently, capture of carbon dioxide is performed on a large scale by absorption of carbon dioxide onto various amine-based solvents. Other techniques have been proposed including pressure swing adsorption, temperature swing adsorption, gas separation membranes, and cryogenics. Pilot studies have included flue capture and conversion to baking soda and the use of algae for conversion to fuel or feed.

In coal-fired power stations, the main alternatives to retrofitting amine-based absorbers to existing power stations are two new technologies: coal gasification combined-cycle and Oxy-fuel combustion. Gasification first produces a “syngas” primarily of hydrogen and carbon monoxide, which is burned, with carbon dioxide filtered from the flue gas. Oxy-fuel combustion burns the coal in oxygen instead of air, producing only carbon dioxide and water vapor, which are relatively easily separated. Oxy-fuel combustion, however, produces very high temperatures, and the materials to withstand its temperatures are still under development.

U.S. Patent Application Publication No. 2005/0154669 describes a carbon credit system wherein a carbon credit product or carbon credit service can be purchased through carbon credit software and which carries a predetermined number of carbon credits. The purchase causes a certificate bearing a carbon credit consumer symbol to be sent to the purchaser. This carbon credit marketing system is designed to enable a consumer to pay for the amount of greenhouse gases he or she produces as a result of his or her consumption of goods and services which effect emission of such gases. This is accomplished though the purchase and sale of carbon credits which in turn correlate to a carbon credit value assigned to a Producer or user. The carbon credit software allows the creation of a client account and maintains a carbon credit balance in the account.

Emissions trading (or “cap and trade”) is an administrative approach designed to control pollution by providing economic incentives for achieving reductions in the emissions of pollutants.

A central authority (usually a government) sets a limit or cap on the amount of a certain pollutant that can be emitted. Companies or other entities are issued emission permits and are required to hold an equivalent number of allowances (or credits) which represent the right to emit a specific amount of that pollutant. The total amount of allowances and credits cannot exceed the cap, thereby limiting total emissions to a certain level. Companies that need to increase their emissions must buy credits from those who pollute less. The transfer of allowances is referred to as a trade. In effect, the buyer is paying a premium for polluting, while the seller is being rewarded for having reduced emissions by more than was required. Thus, in theory, those that can reduce emissions most cheaply will do so, thereby achieving pollution reduction at the lowest possible cost to society. Carbon emissions trading is emissions trading specifically for carbon dioxide (calculated in tons of carbon dioxide equivalent or t CO₂e) and currently makes up the bulk of emissions trading.

The overall goal of an emissions trading plan is to reduce emissions. The cap is usually lowered over time towards a national emissions reduction target. In other systems a portion of all traded credits must be retired, causing a net reduction in emissions each time a trade occurs. In many cap-and-trade systems, organizations which do not pollute may also participate, thus environmental groups can purchase and retire allowances or credits and hence drive up the price of the remainder per the law of supply and demand. Corporations can also prematurely retire allowances by donating them to a nonprofit or charitable entity and then be eligible for a tax deduction. Allowances may be accounted for on the balance sheet of a company as intangible assets

Because emissions trading uses markets to determine how to deal with the problem of pollution, it is often touted as an example of effective free market environmentalism. While the cap is usually set by a political process, individual companies are free to choose how or if they will reduce their emissions. In theory, firms will choose the lowest cost way to comply with the pollution regulation, creating incentives that reduce the cost of achieving a pollution reduction goal.

The textbook emissions trading program can be called a “cap-and-trade” approach in which an aggregate cap on all sources is established and these sources are then allowed to trade among themselves to determine which sources actually emit the total pollution load. An alternative approach is a “baseline and credit program” wherein a group of polluters that are not under an aggregate cap can create credits by reducing their emissions below a baseline level of emissions. These credits can be purchased by polluters that are under a regulatory limit.

There are active trading programs in several pollutants. For greenhouse gases, the largest is currently the European Union Emission Trading Scheme (EU ETS). In the United States the most prominent example of an emission trading system is the SO2 trading system under the framework of the Acid Rain Program of the 1990 Clean Air Act. Under this program, which is essentially a cap-and-trade emissions trading system, SO2 emissions are expected to be reduced by 50% between 1980 and 2010. Several regional markets in nitrous oxide also exist in the United States. Markets for other pollutants tend to be smaller and more localized. In 2003, some corporations began voluntarily trading greenhouse gas emission allowances on the Chicago Climate Exchange.

An emission cap and permit trading system is a quantity instrument because it fixes the overall emission level (quantity) and allows the price to vary. One problem with the cap-and-trade system is the uncertainty of the cost of compliance inasmuch as the price of a permit is not known in advance and will vary according to market conditions. In contrast, an emission tax is a price instrument because it fixes the price while the emission level is allowed to vary according to economic activity. A major drawback of emission taxes is that the environmental outcome (i.e., the quantity of emissions) is not guaranteed.

Some scientists, however, have warned of a threshold in atmospheric concentration of carbon dioxide beyond which a run-away warming effect could take place. If this is a real risk, a quantity instrument could be a better choice because the quantity of emissions may be capped with a higher degree of certainty. However, this may not be true if this risk exists but cannot be attached to a known level of GHG concentration or a known emission pathway.

A third option of the prior art, known as a “safety valve”, is a hybrid of the price and quantity instruments. The system is essentially an emission cap and tradable permit system but the maximum (or minimum) permit price is capped. Emitters have the choice of either obtaining permits in the marketplace or purchasing them from the government at a specified trigger price (which could be adjusted over time). The system is sometimes recommended as a way of overcoming the fundamental disadvantages of both systems by giving governments the flexibility to adjust the system as new information becomes available. By setting the trigger price high enough, or the number of permits low enough, the safety valve can be used to mimic either a pure quantity or pure price mechanism.

The European Union Emission Trading Scheme (or EU ETS) is the largest multi-national, greenhouse gas emissions trading scheme in the world and was created in conjunction with the Kyoto Protocol. It is currently the world's only mandatory carbon trading program.

### Kyoto and the Cap and Trade Carbon Trading System

Kyoto and carbon trading companies have established the “cap and trade system” whereby industry is provided a cap on the amount of hydrocarbon feedstock they may burn.

If these companies wish to use more than their “cap” of hydrocarbon feedstock they must purchase carbon credits in the open carbon trading market. These carbon credits represent an environmental offset and serve to effectively increase the company's allowance and raise their “cap”.

After voluntary trials in the UK and Denmark, Phase I commenced operation in January 2005 with all 15 (now 25 of the 27) member states of the European Union participating. The program caps the amount of carbon dioxide that can be emitted from large installations such as power plants and carbon-intensive factories and covers almost half of the EU's carbon dioxide emissions. Phase I permits participants to trade among themselves and in validated credits from the developing world through the Kyoto Protocol's Clean Development Mechanism. Phase II links the EU ETS to other countries participating in the Kyoto Protocol's trading system.

Over a decade ago, many countries joined an international treaty—the United Nations Framework Convention on Climate Change (UNFCCC)—to begin to consider what might be done to reduce global warming and to cope with any inevitable temperature increases. A number of nations have approved an addition to the treaty, the so-called Kyoto Protocol, which binds most developed nations to a cap-and-trade system for major greenhouse gasses. Emission quotas were agreed upon by each participating country, with the intention of reducing their overall emissions to 1990 levels by the end of 2012. Under the terms of the treaty, nations that emit less than their quota will be able to sell emissions credits to nations that exceed their quota.

It is also possible for developed countries within the trading scheme to sponsor carbon projects that provide a reduction in greenhouse gas emissions in other countries, as a way of generating tradable carbon credits. The Protocol allows this through Clean Development Mechanism (CDM) and Joint Implementation (JI) projects, in order to provide flexible mechanisms to aid regulated entities in meeting their compliance with their caps. CDM is a mechanism under the Kyoto Protocol through which developed countries may finance greenhouse-gas emission reduction or removal projects in developing countries, and receive credits for doing so which they may apply towards meeting mandatory limits on their own emissions. Certified emission reductions (CER)—a Kyoto Protocol unit equal to 1 metric ton of CO₂ equivalent—are issued for emission reductions from CDM project activities. Two special types of CERs called temporary certified emission reduction (tCERs) and long-term certified emission reductions (lCERs) are issued for emission removals from afforestation and reforestation CDM projects. The UNFCCC validates all CDM projects to ensure they create genuine additional savings and that there is no “leakage”—an increase in carbon dioxide emissions by some countries as a reaction to an emission reduction by countries with a strict climate policy.

An enforcement mechanism is a critical part of any emissions trading scheme. Without effective enforcement, the allowances have no value. Two basic schemes have been proposed. In one, regulators measure facilities and fine or sanction those that lack the necessary allowances for their emissions. This scheme is quite expensive to enforce and the burden falls on the agency which may need to collect special taxes to finance the program. The net effect of a poorly financed or corrupt regulatory agency is a discount on emission licenses, and greater pollution.

In another scheme, a third party agency, certified or licensed by the government, verifies that polluting facilities have allowances equal or greater than their emissions. Inspection of the certificates may be performed in some automated fashion by the regulators or as part of tax collection. The regulators then audit licensed facilities chosen at random to verify that the certifying agencies are acting correctly. This scheme places the cost of most regulation on the private sector.

A “carbon offset” is an act by an individual or organization that mitigates (i.e., offsets) greenhouse gas emissions. Thus, one may pay for emission reductions elsewhere rather than reducing one's own emissions. For a given entity, offsets may be a cheaper or more convenient alternative to reducing fossil fuel consumption. In contrast to emissions trading, which is regulated within a legal framework, carbon offsets generally refer to acts by individuals or companies that are arranged by commercial or not-for-profit carbon-offset providers.

Currently used carbon offsets fall into four categories: tree planting, energy conservation, renewable energy and methane capture. Tree planting acts to offset carbon emissions because trees sequester carbon through photosynthesis, converting carbon dioxide and water into molecular oxygen (O2) and plant organic matter, such as carbohydrates (e.g., cellulose). Tree planting includes not only reforestation but also the avoidance of deforestation and afforestation, the establishment of forests on land not previously forested. This can produce higher carbon sequestration rates because the level of carbon in such land is comparatively low. Trees provide other benefits in addition to capturing carbon dioxide, such as providing habitats for animals and renewable resources, such as lumber and other wood-based building materials, and preventing soil erosion.

Energy conservation can constitute a carbon offset by reducing the overall demand for energy. Examples include cogeneration plants that generate both electricity and process heat from the same power source, thus improving the overall energy efficiency of the plant, fuel efficiency projects that replace a device with one which uses less fuel per unit of energy provided such as the substitution of fluorescent lights for incandescent lights. Assuming energy demand does not change, this reduces the total carbon dioxide emitted by the burning of fossil fuels. Another example of energy conservation which may constitute a carbon offset is improved energy efficiency of buildings such as additional (or more effective) insulation, the installation of double-glazed windows and more efficient heating, cooling or lighting systems. New buildings can also be constructed using less carbon-intensive materials.

The development and/or utilization of renewable energy can also be a carbon offset. Currently, wind farms, solar energy installations, hydroelectric facilities and biofuel production are the most common forms of renewable energy. A connection is sometimes made between carbon offsets and renewable energy certificates (RECs), also known as Green Tags. An REC represents a certain quantity of electricity which was generated from renewable sources. By purchasing an REC, the customer pays money to a renewable energy project owner. Typically, the windmill or solar panels have already been installed which leads to lower carbon emissions.

Methane gas has global warming potential 23 times that of carbon dioxide. However, when combusted, each molecule of methane produces one molecule of carbon dioxide. Thus, the collection and combustion of methane may be preferable to merely releasing it into the atmosphere. Some offset projects consist of combusting or containing methane generated by farm animals, landfills or other industrial waste. Methane can also be processed using an anaerobic digester which generates electricity or heat.

Once it has been accredited by the UNFCCC, a carbon offset project can be used as carbon credit and linked with official emission trading schemes, such as the European Union Emission Trading Scheme or Kyoto Protocol, as Certified Emission Reductions.

### Carbon Sequestration and the Subject of Title to CO₂

There are many initiatives to sequester CO₂ by removing it and pumping it into the ground for storage. The issue as to who owns the responsibility of the CO₂ has arisen as there is a significant environmental liability if it leaks from these storage facilities. If a company must take ownership of the “liability” of CO₂ from feedstock, the question becomes what is the chain of title to this cost constituent in feedstock? The answer lies in the agreements which begin with the mineral owner and the mineral lease.

### Venting CO₂ at the Well Head

It is not common knowledge, but gas Producers remove and vent the CO₂ as it is produced at the wellhead. They do this because CO₂ can combine with water to become Carbonic acid which is corrosive to the transport pipelines. An example of a company which provides these services is Crosstex Energy in Dallas, Tex. With the advent of Kyoto, there is the growing realization that these and other normal practices are going to come under greater scrutiny. Producers recognize that the cost of CO₂ in their feedstock and its disposition, may come with significant retroactive liability exposure.

Next and equally systemic to the problems which have been created by Kyoto for the Producers, are the issues of how CO₂ is valued in the marketplace, and what constitutes a true offset. Energy companies believe they are best suited to determine how to solve these kinds of problems.

Recent tax proposals suggest a windfall tax of 25% of Producer's revenues which are not allocated towards alternative energy investments. The bottom line is that the high cost of energy feeds the political process to punish the Producers. Therefore, Producers are incentivized to deal with the issues of CO₂ both economically as well as morally and the ethically. However, like anyone, Producers would rather the solution to issues remain in their hands rather than have rules and policies dictated to them by government or other third parties. The present invention is directed to a system that can be implemented and managed by Producers collectively.

### Protection and Indemnity Clubs—Maritime Industry

Most large shipping companies participate in Protection and Indemnity Clubs. Given that the cost of large oil spills and the respective environmental costs are not insurable, these companies have established clubs which operate where all members agree to contribute to the cost of any one member's catastrophe.

### What is Needed

In the face of the numerous greenhouse gas initiatives, the Producers of hydrocarbons need a way to band together to provide a common solution to the CO₂ issues they all share, while at the same time, capping and sharing potential unknown liabilities amongst themselves, similar to the maritime protection and indemnity clubs.

### BRIEF DESCRIPTION OF THE SEVERAL VIEWS OF THE DRAWING(S)

FIG. 1 is a depiction of prior art Cap and Trade Systems.

FIG. 2 is a depiction of improved Cap and Trade using the present invention.

FIG. 3 is a block diagram showing exchanges with one embodiment of the present invention.

FIG. 4 is a block diagram showing exchanges with a second embodiment of the present invention.

### BRIEF SUMMARY OF THE INVENTION

This invention and business method provides a system for Producers to control risk amongst themselves of liability for CO₂ produced as a byproduct to their production. Since there is a true cost to CO₂ as it is released, and some is removed at the wellhead, systems have been proposed to manage, track, cost value and create a deposit banking system for the Producers for not only what they vent, but that which is inherently in their feedstock.

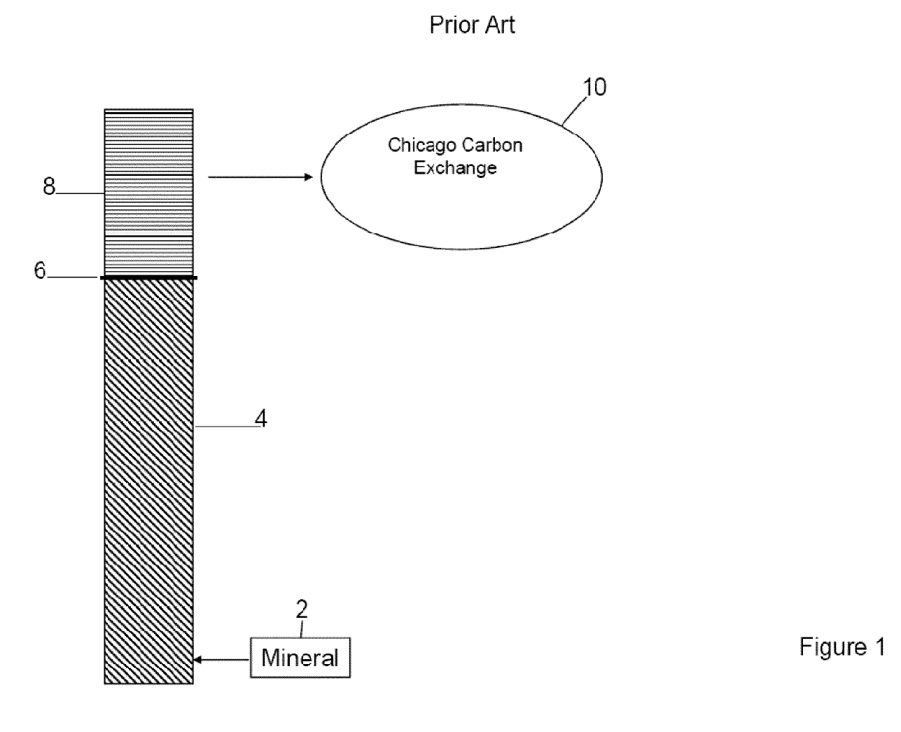

The problem arises under current Cap and Trade Systems, because the cost value (market price) for a ton of carbon is measured on feedstock which is burned above the Cap in the “Cap and Trade” system, see for example, FIG. 1. In FIG. 1, the fuel burning plant, such as a power plant, purchases mineral feedstock 2, such as coal. The plant can burn an amount of coal 4 up to Cap 6. After the plant reaches Cap 6, if it wishes to burn more coal, it must buy additional Cap Space 8 on the open market such as the Chicago Carbon Exchange 10.

The market logic is questioned if the basis behind the world's market system for valuing tons of CO₂ is based on a price above the amount which is “allowed”. This invention provides for a system and electronic trading mechanisms coupled with systems which measure CO₂ on a well by well basis to create a CO₂ derivative to the current Cap and Trade carbon trading markets. That is, the portion of CO₂ which is released by Industry under the “Cap” or under the approved allocation should have a derivative cost value in the system. Therefore, our invention sets the methods and systems to create a Protection and Indemnity Club for our participating members around this derivative of CO₂ pre-ignition and pre-cap; that pollution which is allowed.

The subject of this invention and systems utilizes this well established business structure to join Energy Producers as members of such a club. The purpose of this club is to establish a separate Carbon Trading platform exclusively for its members; this club will manage a two-stage derivative CO₂ trading marketplace as described herein. These Producers and their respective feedstock are separated and serve to provide their customers a separate class of feedstock; a feedstock which may be purchased and burned for a reduced CO₂ offset requirement than feedstock which is sold by non-members.

Members contribute the market value of the CO₂ derivatives at the time feedstock is produced as billed by systems which measure, cost account for electronically, and track on a well by well and mine by mine basis. This contribution serves as a premium in return receiving from the club protection from the liability for all CO₂ contained in their feedstock. The Membership Club participates in the World Markets and provides these resources to mitigate these derivative products by investment into projects as approved by Kyoto and the World Bank. Therefore, companies who have reached their cap have an option to purchase Member Feedstock where a portion or derivative of the CO₂ has been offset “pre-cap”. The market will determine what portion and what volume of the two stage derivates serve to reduce the cost of offset requirements for companies which wish to go past their cap.

### DETAILED DESCRIPTION OF THE INVENTION

The present invention provides for a two stage derivative of CO₂ measurement and management where:

### Stage 1

### Pre-Ignited CO₂ is Measured from the Well Head and Mine

### Stage 2

### CO₂ Released or Vented which is Allowed Under the Cap of the Kyoto Cap and Trade System for Consumption

This invention provides for a Protection and Insurance Club Trading System for Feedstock which is produced; where CO₂ is measured at the well head and mine and allocated to each member according to production daily; where a value is placed on it as a pre-ignited CO₂ derivative; and where its cost value in feedstock is measured for that which is allowed by the cap and trade mechanism; where Members pay this premium to the club based upon the club's agreement to acquire the title and liability to the CO₂ produced; where this feedstock as it moves upstream to be burned may be “virtually contracted and purchased” using electronic and network means; where it is a preferred class of feedstock. It is a preferred Feedstock because a portion of the CO₂ (pre-ignited) in comparison to the post Cap in the Cap and trade system has been accounted for thus requires less offset investment in the Cap and Trade offset Carbon Marketplace.

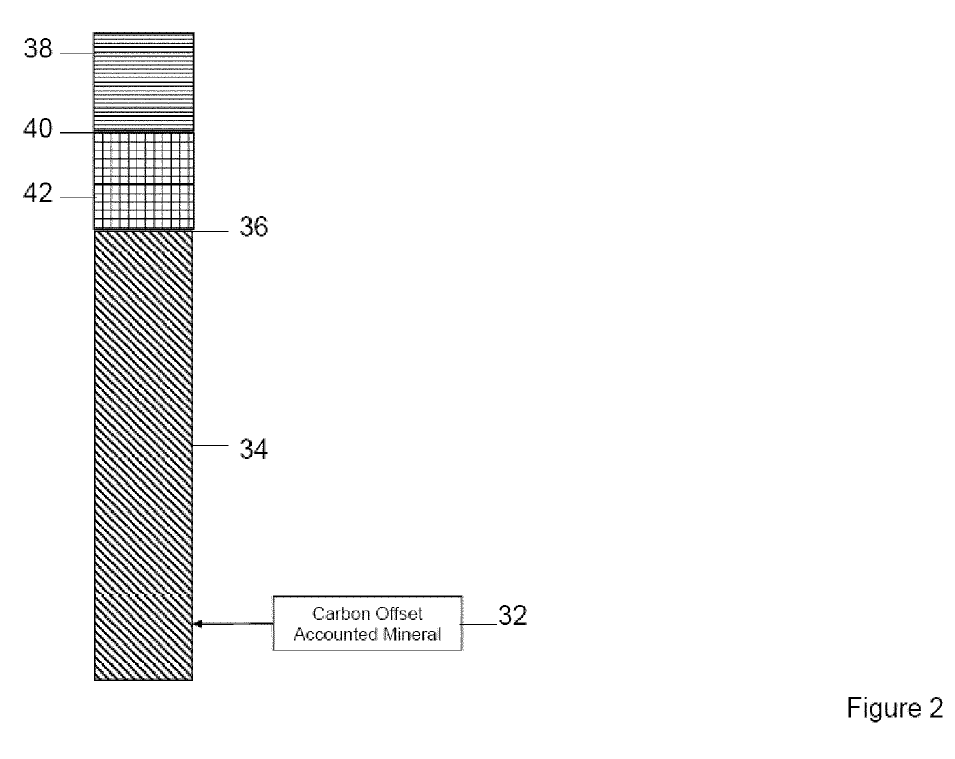

The present invention allows downstream customers of the Producers to take advantage of the fact that the Producers have accounted for the CO₂ inherent in the produced product. At the time of production a measurement is made of the CO₂ in the produced product in its unburned state. A Producer that is then part of the Protection and Insurance Club Trading system can pay the Club to accept a transfer of the liability for the measured amount of CO₂, for any use by any party of the produced product. The Club can then utilize the money to acquire carbon offsets, reward Club members for carbon offset activities of their own, reward Club members for alternative energy research and development. Based on the Club's efforts the Club can apply for carbon offset credit for Club member produced products under such protocols as the Kyoto protocol. A system detailing valuation and banking of carbon credits was disclosed in commonly assigned U.S. patent application Ser. No. 12/047,204, filed Mar. 12, 2008, entitled, “System and Method for Banking Downstream Resource Costs,” hereby incorporated by reference. A benefit to Club members then may be that purchasers of product from Club members may be able to raise their Cap for production of CO₂ since that CO₂ has at least in part been accounted for as shown in FIG. 2. Therefore, if an end user utility company had a previous Cap under a Cap and Trade process of X cubic tons per day, they may be able to increase that Cap by 20% without having to by the extra allowance on the open market as a result of using a Producer's feedstock, as shown in FIG. 2. In FIG. 2, the fuel burning plant buys carbon offset accounted feed stock 32 that either has all or part of the CO₂ release accounted for. If the accounting was for all CO₂, no Cap should apply, if the accounting for CO₂ was only partial, then the Cap should be raised. For instance, if normal fuel was used, only the amount of fuel 34 could be burned up to Cap 36. However, since carbon offset accounted minerals 32 are burned, an additional amount 42 can be burned up to new Cap 40. Additional Cap 38 could then be purchased on the open market if necessary. This is a benefit to the end user that may result in the Producer being able to demand a higher price for their feedstock.

If at the end of a time period, the Club has paid out more than it has received from Club members, the members can agree to make up the shortfall. This can be done on the basis of any formula. One such formula could consider the amount of CO₂ liability assumed from each Producer and the shortfall could be made up in proportion to the liability accepted. The shortfall could simply be paid based on a prearranged agreement. If at some point in the future a Producer incurred liability through litigation, government action or otherwise based on the CO₂ liability assumed by the Club, the Club would pay for any such liability and if that caused a shortfall, then the Producers would be liable to make up the shortfall in any way they had agreed, including the examples above. The Club likewise would have a mechanism to deal with Producers that wish to leave the Club but have assigned CO₂ liability to the Club that potentially could cause the Club a shortfall in the future in that Producer's absence.

A variation on the protection and indemnity club concept is where a group of oil/mineral producers get together to form a community to responsibly deal with CO₂ or other pollutant issues, while at the same time benefitting community members through efficient investment in carbon offsets and the creation of products incorporating an accounting for CO₂ offset (other other pollutants), carbon offset accounted products. Rather than having the club assume title and liability for the CO₂ or other pollutants, the community finds ways to responsibly deal with the CO₂ produced as part of its activities.

For example as described, when the mineral is produced an assessment of the eventual CO₂ production amount of the mineral is made and an amount contributed to the community fund to reflect some or all of the value of the estimated CO₂ or other pollutant impact. The community fund then is responsible for purchasing carbon offsets, or investing in activities that create carbon offsets for the community. For instance, the community may invest in creation of natural gas fired power plants to replace coal fired plants, thus greatly reducing the CO₂ emissions. The community could invest in alternative energy sources. The community gets the benefit of the combined buying power of all the community members, and the community has the autonomy to pursue carbon offset opportunities that it independently believes will provide the best return for the community. The producers get the benefit of producing product that has accounted for all or part of the CO₂ emission expected from the product such that the product will have a higher value when sold. Alternatively, the community could sell the carbon offset accounted product and have the community members share in the profit. If a plant has already reached its cap and trade limits, rather than buy cap space from other plants, it could simply purchase community members' product that comes with the carbon offset already, as shown in FIG. 2. The overall global community benefits because this community effort does not account for CO₂ or other pollutants only above a certain level (such as cap and trade), but instead accounts for all CO₂.

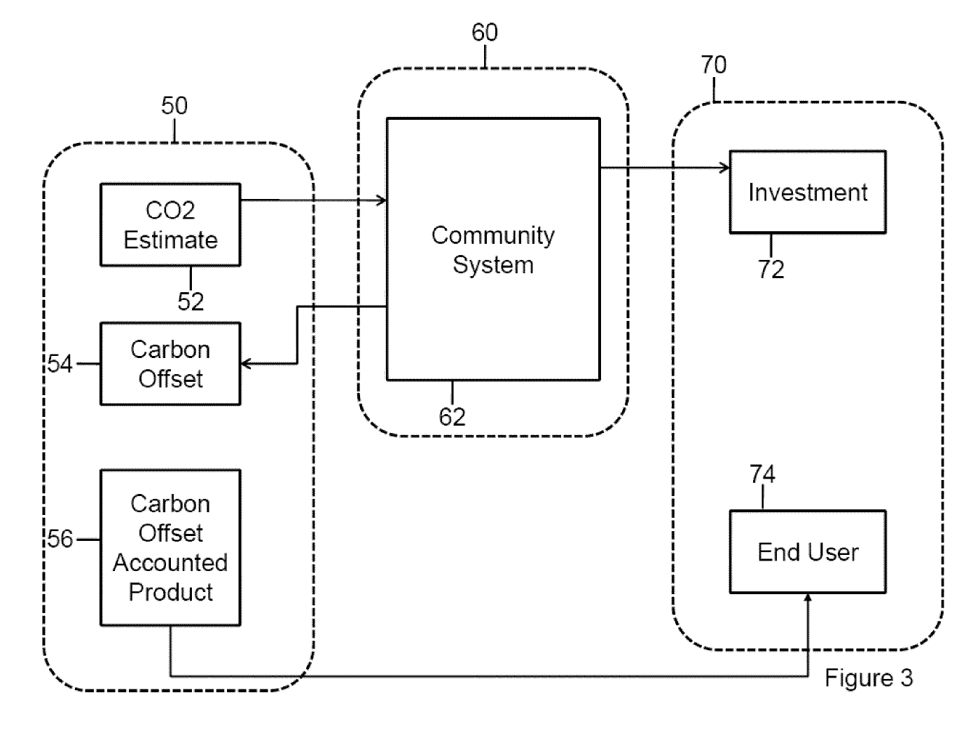

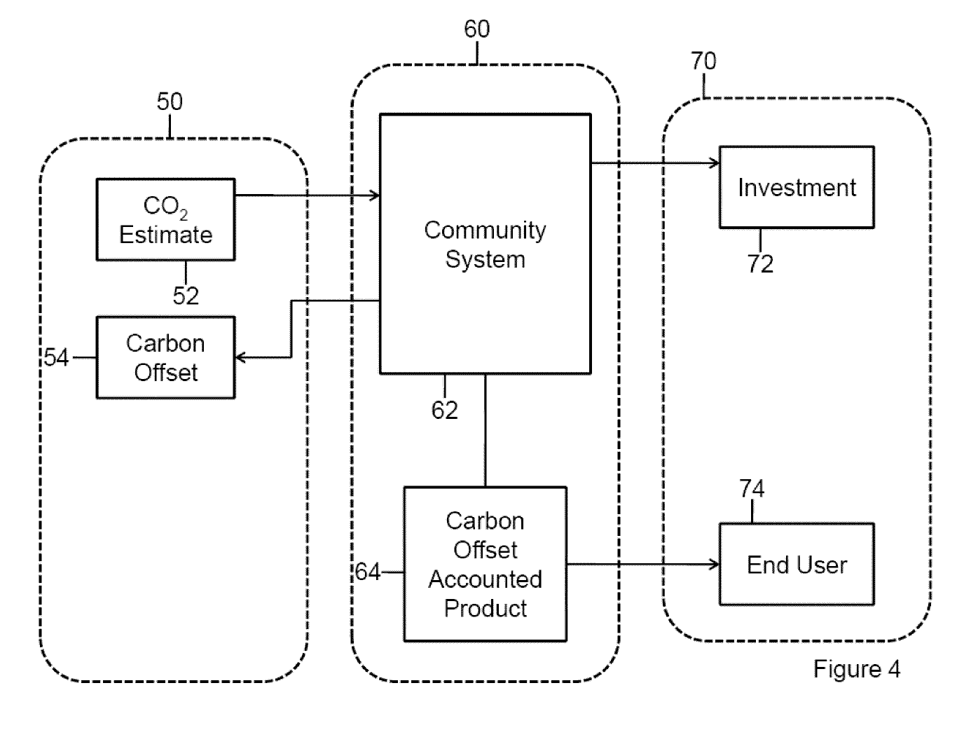

Two different embodiments are shown in FIGS. 3 and 4. In FIG. 3, the mineral producers 50, the community 60, and third parties 70 act together under the direction of the community with the assistance of the community system 62 to accomplish the benefits described herein. The mineral producers 50 submit CO₂ estimates 52 to the community system 62 of all minerals produced at the time of production. The mineral producers 50 pay into the community 60 an amount of money to reflect the value assigned by the community 60 to the CO₂ estimate 52. The community system 62 is used to assess the value of the CO₂ and track payments received. The community 60 then makes investments 72 in carbon offset activities. The community system 62 tracks the offset investments. The community system 62 then accounts back to the mineral producers 50 for the carbon offsets 54. The producers 50 then can produce carbon offset accounted product 56 that can be sold to end users 74. FIG. 4 shows on additional alternative where all is the same but instead of producers 50, the community 60, actually produces and sells the carbon offset accounted product 64.

1. A computer system to manage accounts for a carbon offset community comprising one or more processors programmed to:
a. Receive pollutant content information per community member per mineral source;
b. Assign a community charge for the amount of pollutant content
c. Track carbon offsets purchased with community funds; and
d. Generate reports for community members showing the carbon offsets for the mineral stream from the community member

2. A method of creating a mineral resource product that has accounted for carbon offsets comprising:
e. Creating a community of mineral producers
f. Setting up a community fund
g. Assessing the CO₂ production potential of mineral as it is produced
h. determining a carbon offset value to the produced mineral
i. Each mineral producer paying into the community fund to account for the determined carbon offset value of the produced minerals
j. Utilizing the community fund to invest in activities that generate carbon offset to cover the minerals produced by the mineral producers that are part of the community; and
k. Authenticating the eventual mineral product sold as having carbon offset included.

3. The method of claim 2 wherein the authenticated carbon offset is for a partial offset of the CO₂ to be released.

4. The method of claim 2 where in mineral product that is sold is sold by the mineral producer.

5. The method of claim 2 wherein the mineral product that is sold is sold by the community of mineral producers.
